(19) United States
(12) Patent Application Publication
(10) Pub. No.: US 2025/0054060 A1
(43) Pub. Date: Feb. 13, 2025

(54) SYSTEM AND METHOD FOR MANAGING FRACTIONAL SHARES OF EXCHANGE TRADED FUNDS IN RETIREMENT PLANS

(71) Applicant: Charles Schwab & Co., Inc., San Francisco, CA (US)

(72) Inventors: Jeffrey CASS, Chagrin Falls, OH (US); Lisa DALLAS, Medina, OH (US); Clint SMITH, Tempe, AZ (US)

(73) Assignee: Charles Schwab & Co., Inc., San Francisco, CA (US)

(21) Appl. No.: 18/783,716

(22) Filed: Jul. 25, 2024

Related U.S. Application Data
(63) Continuation of application No. 14/505,305, filed on Oct. 2, 2014, now abandoned.
(60) Provisional application No. 61/934,991, filed on Feb. 3, 2014.
(60) Provisional application No. 61/886,024, filed on Oct. 2, 2013.

(51) Int. Cl. G06Q 40/04

(52) U.S. Cl. CPC G06Q 40/04

(57) ABSTRACT

A method for processing a plurality of orders of shares of exchange traded funds for retirement plans includes providing a pool of at least one share of each of the exchange traded funds to be traded by the retirement plans, receiving an order from a retirement plan that specifies a first amount other than a whole number of shares of an exchange traded fund, identifying a second amount that is a whole number of shares nearest to the first amount, adding, from the pool, a number of shares to the first amount such that a sum of the number of shares and the first amount equals the second amount, directing an exchange to execute a trade for the second amount, and allocating the first amount to the retirement plan and a difference between the first amount and the second amount to the pool.

### RELATED APPLICATIONS

This application is a Continuation of U.S. patent application Ser. No. 14/505,305, filed Oct. 2, 2014, which claims the benefit of U.S. Provisional Patent Application No. 61/886,024, filed Oct. 2, 2013, and U.S. Provisional Patent Application No. 61/934,991, filed Feb. 3, 2014, each of which is incorporated herein by reference in its entirety.

### FIELD OF THE INVENTION

The present invention is related to computer software and more specifically to computer software for retirement plans.

### BACKGROUND OF THE INVENTION

A retirement plan is directed by a plan administrator and receives contributions and redemption requests from plan participants.

Many conventional retirement plans allow trading of shares, for example of mutual funds, typically trading whole shares at an end of day price. Such trading is suboptimal. What is needed is a system and method that can improve trading of securities in a retirement plan.

### SUMMARY OF INVENTION

A system and method receives and stores identifiers of permissible ETFs or other investments, referred to as a plan universe, that can be made available for participants of any number of plans to trade under their retirement plans. For each of several plans, plan additions may be received and stored. Plan additions are other investments that may be permissible to be traded by one plan, or fewer than all plans, managed as described herein.

For each plan, identifiers of some or all of the investments in the plan universe and any plan additions are selected by a plan administrator or other representative as those securities that are permissible to be traded by participants of that plan using that plan.

Each plan participant may designate in advance how subsequent contributions or redemptions from that participant will be used to generate trades for the participant's plan account unless otherwise specified. For example, a participant may specify that contributions made via an automatic payroll deduction should be invested 35% in ETF ABC and 65% in ETF XYZ, or $100 in ETF ABC and the remainder in ETF XYZ. In one embodiment, the participant can change these allocations at certain times or at any time, or can specify a different allocation to be used for a specific contribution or redemption, such as the next contribution received or the next contribution received in a specified amount.

The system and method receives, at a record keeping system, orders, contributions to the retirement plan and redemption requests from the retirement plan from plan participants that cause the permissible investments for the plan under which the participant is participating to be traded. An allocation of the contribution or redemption to one or more securities may also be received. Although orders, contributions, redemption requests and allocations are received from plan participants as described herein, any of them may be received from other parties such as plan administrators (also known as plan sponsors), agents of the plan participant (e.g. wealth advisors) and other parties. Allocations may be used to convert contributions or redemption requests of the plan into one or more orders to trade securities. Such allocations may either be specified with each such contribution or redemption or a standing allocation received previously may be used to convert for each contribution or redemption into one or more orders unless overridden. An order may be received without a contribution or redemption request, for example as a trading order to trade one or more securities, for example, for cash.

The system and method provides the one or more orders received or resulting from such a conversion, to a trust that manages trading for plan participants of multiple plans to buy or sell ETF shares or other securities permissible to be traded under the plan corresponding to the participant. In some circumstances, the system and method optionally aggregates orders from the different participants of the same plan and supplies one aggregated order to the trust from such participant orders.

Each order may be for a number of whole shares of an ETF or other security, and optionally a number of fractional shares, less than a whole number, of shares of the ETF or other security. For example, one order may be for 100.5 (including 0.5 fractional shares) shares of one ETF and another order may be for 100 shares of another ETF. For example, contributions and redemption requests may be received in the form of dollars, and converted into one or more orders for ETF shares or shares of other securities, either at the record keeping system or at the trust, and such conversion may include a fractional component (e.g. a nonzero amount to the right of the decimal) of a number of shares of any ETF or other security. Although ETFs are specified herein, orders may include ETFs or other securities, and orders for other securities are processed in the same manner as ETFs described herein.

At the trust, an order for an ETF or other security is selected for processing, and if the selected order includes fractional shares, a rounding rule is applied to round the order up or down to a whole number of shares, and the rounded order, or the original order, if no fractional shares were included in it, for a whole number of ETF shares is placed from an omnibus account of the trust for all plans at a broker dealer, for example, via a conventional stock exchange, although other trading methods may be used as described in more detail herein. Any excess fractional share from any rounding is purchased by a recon outage subaccount for that ETF in the omnibus account. Any deficit fractional share from rounding (for example, from a buy order rounded down or a sell order rounded up) is sold to the plan participant or participants (for an aggregated order) from the recon outage subaccount for the ETF being ordered at the price for the remaining ETF shares in the order.

Although some orders may be aggregated and traded at the end of the day, other orders are traded as received throughout the trading day, at the then current market price. Such orders are settled 3 days after the trade date (T+3) as opposed to settling the next day for orders traded after the close of the market. Thus, the plan participants have certain trading freedoms they would have in a regular brokerage account. Each transaction can generate a fractional share transaction, and multiple transactions throughout the day will generate at least one fractional share transaction.

If any ETF or other security described above is being purchased in a fractional share amount other than zero as described herein, if a recon outage amount of the ETF or other security is not already being managed as described herein, the trust is informed, and a target number of shares of the ETF are added to a recon outage subaccount for that ETF that is held by the trust for all plans, in an omnibus account at the broker dealer used by the trust to process orders to buy or sell ETFs from plan participants. Subaccounts need not actually be used, as all shares may be held in a single omnibus account, though the subaccounts may be used herein for purposes of description. The target number of shares is specified as described below.

The record keeping system allocates any shares or cash received or paid to the corresponding plan participant and to the corresponding plan.

If there are more orders, the next order is selected by the trust, and the method repeats with the newly selected order. Parallel processing of orders may also be performed.

In one embodiment, after each order is executed, or in parallel with that process, the amount of the recon outage for any ETF or other security may be calculated to identify a current amount in the recon outage after the order is executed via the omnibus account. Four thresholds and a target level are received for each ETF and each other security (or all ETFs and all securities) from a system administrator, ordered, from lowest to highest: a lower policy threshold, a lower threshold, the target, an upper threshold, and an upper policy threshold, and the amount of recon outage computed is compared to the four thresholds. In one embodiment, the upper and lower policy thresholds are one share above or below, the upper and lower thresholds, respectively.

If the amount of shares held in the recon outage subaccount for an ETF or other securities in the omnibus account is below the lower threshold, one or more additional shares of the ETF or other security are purchased by the trust using a proprietary account of the trust in an amount of whole shares that will bring the shares held in that recon outage subaccount nearest to the target level, and then the shares purchased are transferred into the recon outage subaccount for that ETF in the omnibus account.

If the amount of shares held in a recon outage subaccount of the ETF are above the upper threshold, a number of whole shares are transferred from the recon outage subaccount for that ETF to the proprietary account to bring the number of shares held in that recon outage subaccount nearest to the target level and the shares are sold from the proprietary account.

As noted, there are two policy thresholds (for each ETF or other security in the plan universe or plan additions or all such ETFs and other securities), an upper policy threshold and a lower policy threshold that are both outside the range of the upper threshold to the lower threshold described above. If the number of shares in the omnibus account for an ETF is outside of the range of the upper and lower thresholds before the shares are transferred between the omnibus account and the proprietary account, if the number of shares in the omnibus account for that ETF or other security is additionally outside the range of the upper to lower policy thresholds, an exception report is generated to a management team to inform them that one of the policy thresholds have been violated, by listing the number of shares held, the threshold violated, the name or other identifier of the ETF or other security and the date and time. The management team may take suitable corrective measures using the report to prevent further violations of the policy thresholds, such as by expanding or contracting the thresholds for the security, adopting a different rounding rule, or by using other methods. Such corrective measures may be implemented automatically in response to the recon outage quantity for the security being outside of a policy threshold.

In one embodiment, at the end of each trading day, each security for which a recon outage is being maintained is traded in whole shares, if necessary, to bring the quantity of the recon outage above or equal to zero, but below one share, by transferring any whole share excess or deficit to the proprietary account of the trust at the broker dealer and making a trade of such excess or deficit in an after hours market from the proprietary account at the broker dealer. Other methods of minimizing after hours and overnight investment risk may be used, for example, by performing the above action for a security that has not been traded for a threshold amount of time.

In one embodiment, orders placed by plan participants may be market orders as described above, although other orders may also be used. Market orders may be the result of algorithmic trading, for example by a wealth management firm or other type of financial services firm or by the plan administrator. Such trading may take advantage of market opportunities, or may spread large orders over a period of time to avoid substantially moving the market with the order. Other types of orders may include stop orders, limit orders, or stop limit orders, triggered by an intraday market price above or below a threshold. For such orders, the recon outage transactions, if any, are performed upon execution of the fractional share portion of the order, if any. Such execution may be the last part of a trade, of the trade, such as a limit order, is executed in different parts, but parts other than the last part may be used for this purpose.

Orders may be placed for a number of shares, or an amount of money. The amount of money may be considered a target, with the actual amount invested or obtained to be different, or may be dollar certain, that is, all or nearly all of the funds will be used to purchase shares, or all or nearly all of the money specified will be available from the sale of shares, including fractional shares, optionally using repeated transactions by the trust or a broker-dealer or other party, if necessary, to trade as close as possible to the specified dollar amount using whole share (i.e. not fractional) trades. The use of fractional shares allows most or all of the funds to be used, with the fractional share trade executed with the recon outage at the average execution price, last execution price, highest execution price, lowest execution price, or another price.

To execute orders, the broker-dealer may purchase or sell shares using a conventional stock market, or, for larger orders, the trust or broker dealer may deal directly with the operator of an ETF as an authorized participant or may deal with an authorized participant of an ETF to purchase and redeem creation units in order to fulfill orders in ETFs. Alternatively, the trust or broker dealer may fulfill orders to buy or sell shares using negotiated transactions with a party who is known to wish to purchase or sell a block of shares of one or more ETFs or other securities, or who is located to do so, such as via a conventional risk bid.

Because the orders corresponding to contributions or redemptions may be executed right away, the funds from such trades may be used or made available to the plan participant before the end of the trading day. Thus, contributions and redemptions may be processed throughout the day, and not batched and processed at the end of the day.

### BRIEF DESCRIPTION OF THE DRAWINGS

FIG. 1 is a block schematic diagram of a conventional computer system.

FIG. 2A is a portion of a flowchart illustrating a method of managing fractional shares of Exchange-Traded Funds handled by a retirement plan according to one embodiment of the present invention.

FIG. 2B is another portion of the flowchart illustrating the method of managing fractional shares of Exchange-Traded Funds handled by a retirement plan according to one embodiment of the present invention.

FIG. 2C is another portion of the flowchart illustrating the method of managing fractional shares of Exchange-Traded Funds handled by a retirement plan according to one embodiment of the present invention.

FIG. 2D is another portion of the flowchart illustrating the method of managing fractional shares of Exchange-Traded Funds handled by a retirement plan according to one embodiment of the present invention.

FIG. 3 is a block-schematic diagram of a system for managing fractional shares of Exchange-Traded Funds according to one embodiment of the present invention.

### DETAILED DESCRIPTION OF A PREFERRED EMBODIMENT

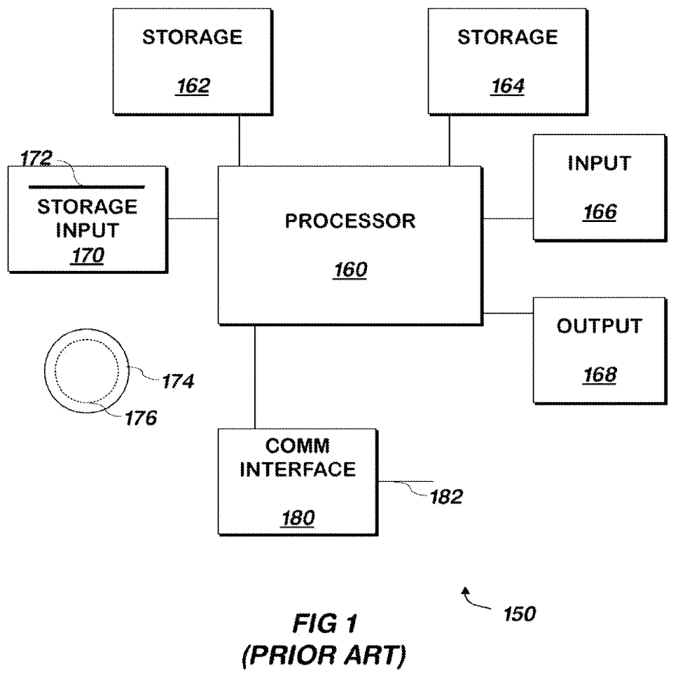

The present invention may be implemented as computer software on a conventional computer system. Referring now to FIG. 1, a conventional computer system 150 for practicing the present invention is shown. Processor 160 retrieves and executes software instructions stored in storage 162 such as memory, which may be Random Access Memory (RAM) and may control other components to perform the present invention. Storage 162 may be used to store program instructions or data or both. Storage 164, such as a computer disk drive or other nonvolatile storage, may provide storage of data or program instructions. In one embodiment, storage 164 provides longer term storage of instructions and data, with storage 162 providing storage for data or instructions that may only be required for a shorter time than that of storage 164. Input device 166 such as a computer keyboard or mouse or both allows user input to the system 150. Output 168, such as a display or printer, allows the system to provide information such as instructions, data or other information to the user of the system 150. Storage input device 170 such as a conventional floppy disk drive or CD-ROM drive accepts via input 172 computer program products 174 such as a conventional floppy disk or CD-ROM or other nonvolatile storage media that may be used to transport computer instructions or data to the system 150. Computer program product 174 has encoded thereon computer readable program code devices 176, such as magnetic charges in the case of a floppy disk or optical encodings in the case of a CD-ROM which are encoded as program instructions, data or both to configure the computer system 150 to operate as described below. All elements labeled with the word ‘storage’ may contain memory or disk storage and may contain a conventional database.

In one embodiment, each computer system 150 is a conventional SUN MICROSYSTEMS T SERIES SERVER running the SOLARIS operating system commercially available from ORACLE CORPORATION of Redwood Shores, California, a PENTIUM-compatible personal computer system such as are available from DELL COMPUTER CORPORATION of Round Rock, Texas running a version of the WINDOWS operating system (such as XP, VISTA, or 7) commercially available from MICROSOFT Corporation of Redmond Washington or a Macintosh computer system running the MACOS or OPENSTEP operating system commercially available from APPLE INCORPORATED of Cupertino, California and the FIREFOX browser commercially available from MOZILLA FOUNDATION of Mountain View, California or INTERNET EXPLORER browser commercially available from MICROSOFT above, although other systems may be used. Each computer system 150 may be a SAMSUNG GALAXY NEXUS III commercially available from SAMSUNG ELECTRONICS GLOBAL of Seoul, Korea running the ANDROID operating system commercially available from GOOGLE, INC. of Mountain View, California. Various computer systems may be employed, with the various computer systems communicating with one another via the Internet, a conventional cellular telephone network, an Ethernet network, or all of these.

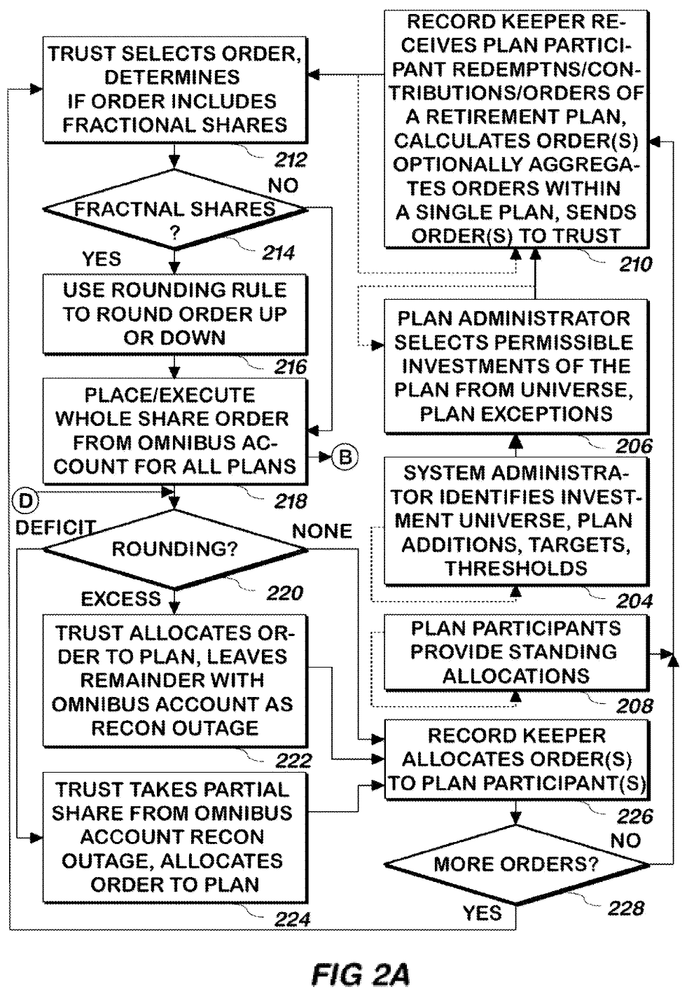

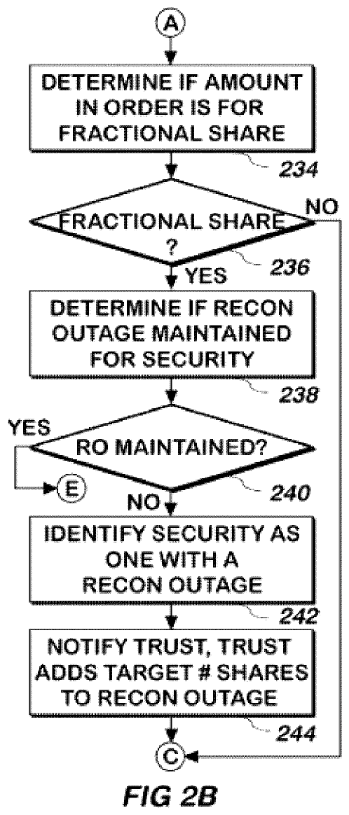

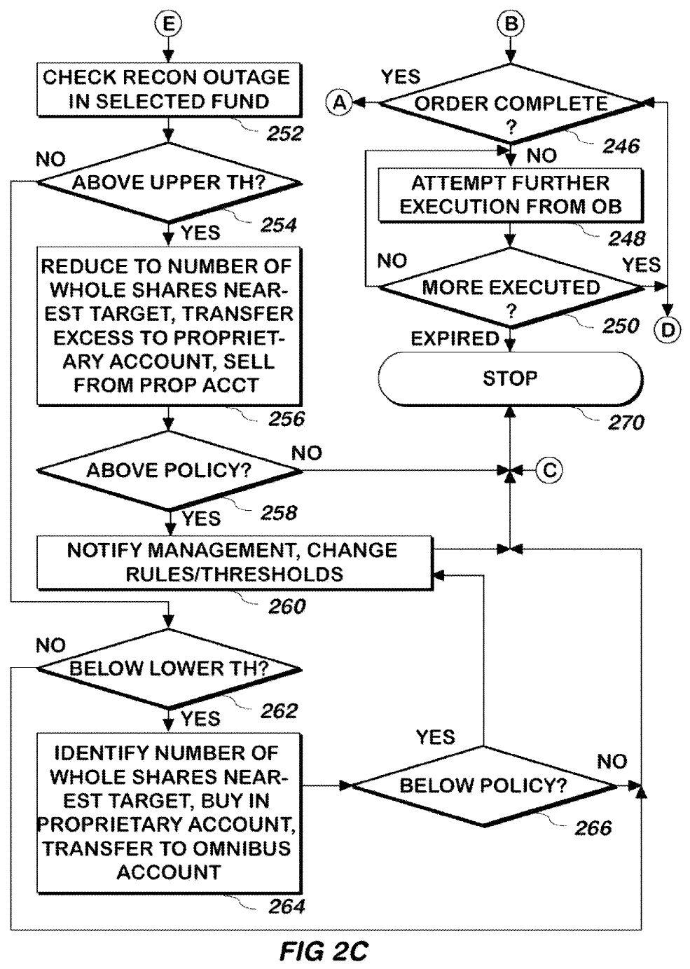

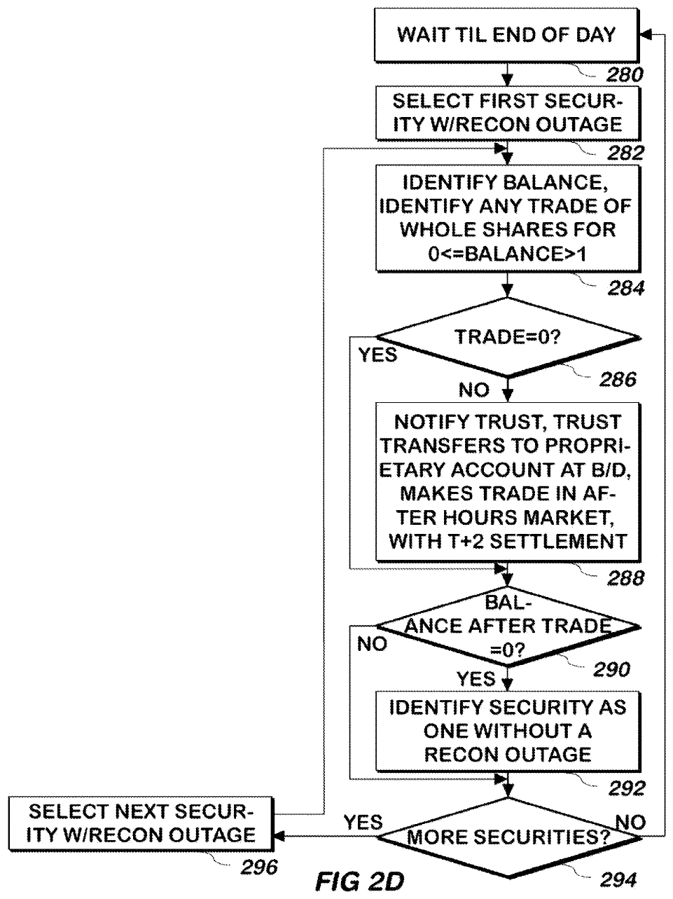

FIGS. 2A, 2B, 2C, and 2D are a flowchart illustrating a method of managing and allocating trading of fractional shares of ETFs and other securities according to one embodiment of the present invention.

### I. System Setup.

### Receive Investment Universe, and Plan Additions; Receive Plan Investment Options.

Referring now to FIGS. 2A, 2B, 2C, and 2D, an investment universe corresponding to securities that many be selected for use in any number of retirement plans (e.g. 2 or more) run by a plan administrator may be received 204 from a system administrator. The investment universe may include any number of ETF identifiers corresponding to each of any Exchange Traded Funds (ETFs), and identifiers of other securities, such as stocks or money market accounts. The investment universe may be used by each administrator of several retirement plans to select investments that will be available to participants of the plan as described below and may be fewer than all of the investments in the securities markets. The investment universe is a superset of investments from which each plan administrator or their agent may chose to include in the retirement plan being administered by that administrator or agent.

Step 204 may include receiving from the system administrator, for each of several retirement plans, plan additions, and the plan identifier of any plan to which the addition may be added. Plan additions are investments that are not part of the investment universe that may be added to a specific plan. For example, a plan addition may be the common stock of a company whose employees and retirees are the plan participants. As used herein, a “plan” is a retirement plan. The system and method may be used by other groups of investors.

As part of step 204, a target number of shares and the four thresholds described below may also be received for each of the securities in the investment universe and the plan additions. In one embodiment, all such securities use the same target and thresholds, and in another embodiment, each security may be assigned its own target and thresholds. Securities may be assigned to classes, which have a defined target and threshold for each security in the class, and the target and thresholds of the security then inherits the target and thresholds of the class to which it is assigned.

The investment universe and plan additions and targets and thresholds may be received and updated at any time as indicated by the dashed line in the Figure. Such information may be received and stored on a record keeping system, which includes a conventional server computer system with computer processors coupled to electronic storage as described herein.

At any time, a plan administrator of each of several retirement plans may select 206 securities from the investment universe to include as part of the securities that may be traded under that retirement plan, referred to as permissible investments of the plan. Plan participants and others may then trade such securities as described herein, but, in one embodiment, may not use the retirement plan to trade securities that are not permissible investments of the plan, although there may be exceptions in certain cases, for example, a security that was purchased under a plan as one of the selected securities can also later be sold, even if it is no longer selected for the plan. The selections are stored at the record keeping system for each plan.

The plan additions may also be selected as a part of the permissible investments of the plan, or they may be considered to be automatically selected for the plans for which they were designated.

At any time, a plan participant (or his or her agent) of any plan may supply to the record keeping system, or update, standing allocation instructions for buying securities using plan contributions made by the participant or on behalf of that participant, and for selling securities in response to redemption requests made by the participant or on his or her behalf, and such standing instructions are received 208 and stored at the record keeping system associated with the plan participant. The plan participant may override standing allocation instructions (also referred to as the “standing instructions”) for any specified contribution or redemption.

Standing allocation instructions describe how to convert the contribution or redemption request into one or more orders, such as “the first $200 from a contribution should be invested in ETF abc, and the remainder, if any, should be invested 50% in ETF def and 50% in ETF xyz”.

### II. Processing of Orders.

Record Keeper Receives Plan Participant Orders, Optionally Aggregates Orders Within A Single Plan, Sends To Trust.

Any number of participant redemption requests, contributions or orders may be received by the record keeping system from any number of the multiple plan participants corresponding to each of any number of retirement plans 210. When a contribution or redemption request is received, it may be converted to one or more orders for securities using either allocation instructions received with the contribution or redemption request, or if none have been received, using the standing allocation instructions of the plan participant from which the contribution or redemption request was received. Thus, a participant redemption received from a plan participant is converted into one or more orders to sell securities (and optionally withdraw funds) corresponding to a specified retirement plan in which the plan participant is enrolled. A participant contribution similarly is converted into one or more orders to purchase securities, either using instructions received with the contribution or using the standing instructions if no instructions are received with the contribution.

Any number of orders to trade one or more securities (including an order to sell and then a dollar certain order to buy a different security for the amount of the proceeds from the sale) may also be received from the plan participant, or his or her agent. Proceeds from a sale order may be used to generate one or more buy orders according to a standing instruction. In one embodiment, orders may be received to buy or sell permissible investments of the plan, but not other investments, with certain exceptions. In one embodiment, a plan participant may be any person enrolled in one or more of the retirement plans for which the record keeper has received permissible investments of that plan.

Participant orders, redemption requests and/or contributions may be received at any time by the record keeper corresponding to any number of retirement plans, such as via a website operated by the record keeper or by the plan administrator running the retirement plan or plans, or via any hard copy documents received from the retirement plan participant in person or through a postal service, or via regular or irregular electronic or manual deposits made into or out of the plan participant's retirement account (e.g. deductions from the participant's paycheck into his or her retirement account), or in any other manner. In one embodiment, a participant order, redemption request or contribution may include an identifier that identifies the participant and, optionally, the retirement plan.

In one embodiment, multiple participant orders received by themselves or converted from redemption requests or contributions received corresponding to a single retirement plan may be optionally aggregated, and an (optionally aggregated) ETF or other security order corresponding to such order, redemption request or contribution for such single retirement plan may be sent by the record keeper to a trust as part of step 210. In one embodiment, the trust is an entity authorized to buy and sell shares of such securities ordered under a retirement plan and may hold such securities and cash on behalf of the plan under the participant trades. Orders that will not be aggregated are sent to the trust as they are received or converted.

To optionally aggregate ETF orders, orders for a security that are of the same type (e.g. market orders) and for participants of the same plan may be summed to place a single order. Limit and other types of orders received on the same day may also be aggregated in a similar fashion if they are for participants of the same plan, and have the same threshold or thresholds. Orders from participants of different plans may not be aggregated, in one embodiment.

In one embodiment, none, some, or all of any participant orders, for the same retirement plan and security which are received by the record keeper during a given time period, such as one business day, may be aggregated such that one aggregate order is sent to the trust from such orders for each of any securities specified in that retirement plan, for example at the end of the business day. In one embodiment, participant orders, redemption requests and contributions received via mail may be aggregated, and participant orders, redemption requests and contributions received electronically via the website operated by the record keeper or plan administrator may not be aggregated. In one embodiment, orders to buy are aggregated with orders to buy, but not orders to sell, and in another embodiment, the aggregation may include offsetting buy orders with sell orders and supplying one net order, with the shares offset being priced at the price at which the net order is filled. An order may be fulfilled without a redemption request or contribution by using cash or a sweep security specified by the investor or the plan administrator as part of the standing allocation instructions of step 208 in which excess cash is automatically invested.

In one embodiment, orders placed by plan participants or others may be conventional market orders as described above, although other orders may also be placed, and such orders are executed in a conventional manner. Market orders may be the result of algorithmic trading, for example by a wealth management firm or other type of financial services firm, or by the plan administrator, for example to trade all participants who have positions in an ETF out of that ETF and into another. Such algorithmic trading may take advantage of market opportunities, or may spread large orders over a period of time to avoid substantially moving the market with the order.

Other types of orders may be placed by a plan participant or other party, such as stop orders, limit orders, or stop limit orders, triggered by an intraday market price above or below a threshold, and the type of order and threshold are received by the record keeping system with the order. A limit order is an order to trade at or better than a threshold price. A stop order becomes a market order once a security trades through a threshold. A stop limit order becomes a stop order at a second threshold once the security trades through a first threshold price; with the second threshold being the same or different from the first threshold. All such orders may be traded via a retirement plan as described herein, and may include fractional share amounts.

Any number of participant orders, redemption requests and/or contributions may be received by the record keeper from any number of plan participants corresponding to any number of retirement plans at any time, and any number of ETF or other security orders corresponding to such participant redemptions and contributions may be sent by the record keeper to the trust at any time, either immediately or after aggregation. The process of the record keeper receiving participant orders, redemption requests and contributions from plan participants, optionally converting them via allocation instructions, and sending orders to the trust may be an independently operating process, as shown by the dashed line in the Figure. In one embodiment orders may be sent to the trust in share amounts or dollar certain amounts.

When the trust receives an order, it receives the order with an identifier of the retirement plan, an identifier of the security to be traded, a number of shares or dollars to trade, an indication of whether the trade is a purchase or a sale of the security, the type of order: market, stop, limit, stop limit or dollar certain, optionally other conventional parameters associated with a stop, limit, stop limit or dollar certain order, such as the threshold or thresholds. Such information may be generated by the record keeping system as described above and received at the record keeping system with the order.

Orders are assumed to be market orders unless specified otherwise. Market orders are assumed for the purpose of the next portion of the description below. Following that description, the handling of other types of orders is described.

### Trust Selects First ETF Order And Determines If Order Includes Fractional Shares.

An order, for an ETF or other security, corresponding amount of ETF or other security shares, indication to purchase or sell such ETF or other security shares specified, and a retirement plan identifier, is selected at the trust, and a determination is made whether the amount of ETF or other security shares to purchase or sell corresponding to the selected ETF order includes any fractional shares 212. Orders may be selected in the order received. In one embodiment, the selected order is determined to include fractional shares if the amount of securities included in the order indicates purchasing or selling a number of shares that is not a whole number of shares but includes any fractional portion of a share.

### If Order Includes Fractional Shares, Then Use Rounding Rule To Round Order Up Or Down

If fractional shares are included in the selected order 214, then a rounding rule may be used by the trust to round the number of shares specified in the order up or down to a whole number of shares 216. In one embodiment, a rounding rule may be any rule used in determining the manner in which orders with fractional shares are rounded to allow the trust to purchase or sell a whole number of shares corresponding to the order.

As described herein, because orders are rounded to whole numbers, a recon outage of the trust is used as a reservoir to fulfill fractional share amounts and/or to store any excess. In one embodiment, each security in the plan universe can have a recon outage, stored in a subaccount for that security in an omnibus account used by the trust to hold and trade securities for all plans. For example, if an order is received to purchase 50.5 shares of ETF abc, an order may be rounded up to 51 shares or down to 50 shares. The trust then executes the order and places the excess 0.5 shares into the recon outage for ETF abc or uses 0.5 shares of the recon outage to fulfill the order.

An example of a rounding rule is as follows: the number of shares corresponding to orders including fractional shares may be rounded up or down to the nearest whole number of shares, varyingly, in a manner such that a first order including fractional shares is rounded to cause an excess amount of fractional shares to be held at the trust corresponding to the order, and the next order received including fractional shares may be rounded to cause a deficit in the amount of fractional shares available at the trust corresponding to such order, and the third order is again rounded to cause an excess amount of fractional shares to be held at the trust corresponding to the third order, and so on, and so forth, alternating between causing an excess and causing a deficit in the amount of fractional shares held at the trust corresponding to the security specified in such orders including fractional shares.

In one embodiment, to cause an excess amount of fractional shares to be held at the trust corresponding to an order including fractional shares received from the record keeper, the number of shares corresponding to such order may be rounded up to the nearest whole number if the order is to purchase shares of the security specified, or the number of shares may be rounded down to the nearest whole number if the order is an order to sell shares of the security specified. For example, an order to purchase 50.4 shares of ETF ABC may be rounded up to 51 shares of ETF ABC such that a greater amount of shares of ETF ABC are purchased by the trust corresponding to such ETF order than the amount of shares specified by such order, causing an excess (0.6 shares) in the amount of shares of ETF ABC held at the trust corresponding to the order.

If an order to order to sell 50.4 shares of ETF ABC is received at the trust, then the number of shares corresponding to such order may be rounded down to 50 whole shares to cause an excess (0.4) in the amount of fractional shares of ETF ABC held at the trust corresponding to such order.

To cause a deficit in the amount of shares held at the trust corresponding to an order including fractional shares, the number of shares of the security specified in the order may be rounded down to the nearest whole number if the order is to purchase such shares, or rounded up to the nearest whole number if the order is the sell such shares. For example, if an order sent from the record keeper to the trust is an order to purchase 100.7 shares of ETF ABC using the omnibus account, then the number of shares corresponding to such ETF order may be rounded down to 100 to cause a deficit of 0.7 shares of ETF ABC to be available at the trust corresponding to such order.

If the order received corresponds to an order to sell 100.7 shares of ETF ABC, then 101 shares of ETF ABC may be sold by the trust to cause a deficit of 0.3 shares of ETF ABC to be available at the trust corresponding to such order.

Other rounding rules may be employed. In one embodiment, all transactions containing fractional shares are rounded to cause the recon outage to go up by rounding up orders to buy and rounding down orders to sell. In another embodiment, all orders (buys and sells) are rounded up and in another embodiment, all orders are rounded down.

In still another embodiment, all orders are rounded to cause the recon outage at the trust to increase when the last known amount of the recon outage is below a first threshold, and all orders are rounded to cause the recon outage to decrease when the last known amount of the recon outage is above a second threshold that is higher than the first threshold, both thresholds being within the upper and lower thresholds, for example, 2 shares within each threshold. In between the thresholds, any of the other rules described herein may be used.

### Once Order Does Not Include Fractional Shares, Then Execute Whole Share Order From Omnibus Account For All Plans

Following step 216, or if the selected order does not include any fractional shares 214, then a whole number of shares corresponding to the selected order are purchased or sold by the trust in any conventional manner of purchasing and selling shares, e.g. by the broker dealer using a conventional stock exchange, using an omnibus account of the trust at the broker dealer 218. If the order included fractional shares, the whole number of shares is the number of shares after rounding as described above. In one embodiment, all of any shares, whole and/or fractional, of any Exchange-Traded Funds or other securities purchased, corresponding to any number of retirement plans, may be held in an omnibus account of the trust at the broker dealer. Any monetary funds used to purchase and/or sell such shares corresponding to such retirement plans may additionally be placed in the omnibus account. In one embodiment, the shares held in the omnibus account may be allocated by the trust to the retirement plan or plans for which such securities are held by the trust. Shares are allocated by the record keeping system to allocate securities among participants of a plan.

The method continues at step 220 and step 246 of FIG. 2C.

Referring now to FIG. 2C, at step 246, if the order is complete (a limit order may be partly filled, for example), the method continues at steps 234 of FIG. 2D. Otherwise 246, further execution of the order is attempted 248 and if more of the order is executed 250, the method continues at step 246 and step 220 of FIG. 2A. If the order expires before it is completely executed 250, the branch for fulfilling the order terminates 270.

Execution of Orders May be Performed Via A Stock Exchange, an Authorized Participant or Directly With the ETF Operator, or Via a Negotiated Transaction Such as a Risk Bid.

In one embodiment, the execution of the optionally rounded, whole share portion of the order may be performed using any conventional manner of trading securities, or multiple of such manners may be used to trade a single order, by the trust or via a broker dealer or intermediary. A conventional stock exchange may be used to trade some or all of the order; or a portion or all of the order may be used to purchase or redeem creation units, either via an authorized participant, or if the trust or operator of the record keeping system is an authorized participant, directly with the operator of an ETF; or a conventional negotiated transaction may be used either for one or more of a set of securities or via a risk bid of several securities. Any fractional portion of the remainder of the trade may be made using the recon outage as described herein.

### If Rounding Results In Excess Shares Held By Trust, Then Trust Allocates Order To Plan And Leaves Remainder With Omnibus Account As Recon Outage

If the amount of fractional shares corresponding to the selected ETF order has been rounded to cause an excess in the amount of shares of such security to be held at the trust 220, then the amount of shares specified by the unrounded order received from the record keeper is allocated by the trust to the retirement plan for which such shares are ordered, and the excess amount of fractional shares held by the trust is allocated to a recon outage subaccount (referred to as the “recon outage”) of the omnibus account corresponding to the security specified. The actual number of shares (which may include a fractional component and a whole number component) allocated, and bought or sold by the plan is reported to the plan by the trust, along with the total or average per share price. The price of the fractional share may be reported as the average price per share, or the highest or lowest price per share of the other shares in the order.

In one embodiment, excess shares corresponding to any number of orders may be allocated to recon outage of the omnibus account, and the total amount of excess shares corresponding to each security included in the omnibus account may be tallied by the trust in an ongoing manner, as described herein.

### If Rounding Deficit, Then Trust Takes Fractional Shares From Omnibus Account Recon Outage, Allocates Order To Plan

If the amount of shares corresponding to the order has been rounded to cause a deficit in the amount of fractional shares corresponding to such security to be available at the trust corresponding to such order 220, then such deficit amount of fractional shares is allocated to the order as such from the recon outage of the omnibus account, and the total number of shares corresponding to the selected order are allocated by the trust to the retirement plan specified by the selected order 224. In one embodiment, any excess in monetary funds which remains at the trust corresponding to an executed order causing a deficit in the amount of fractional shares allocated to recon outage of the omnibus account may be transferred to a proprietary account described in more detail below.

By allocating shares to or from recon outage, a whole number of shares may be purchased or sold by the trust via an exchange, yet a fractional number of shares (i.e. a number of shares with a fractional component) may be purchased or sold by the plan participant. The recon outage amount of a security may be affected by multiple plans, as the plans that allow purchasing or selling of a security share the recon outage of that security.

### Record Keeper Allocates Order(s) To Plan Participant(s).

Shares which have been allocated by the trust to each retirement plan in the omnibus account are allocated 226 by the record keeper to one or more individual plan participants according to the participant order or orders received from such plan participants as described above with respect to step 210. In one embodiment, the price at which the fractional component of an order is purchased or sold from the recon outage is the average, highest, or lowest market price at which the remainder of the order was purchased or sold, although other prices may be used.

### Allocation to Recon Outage for Stop, Limit or Stop Limit Orders Is Performed After the Trade.

In one embodiment, stop, limit or stop limit orders are executed as part of step 218 by the trust providing the type of order and threshold or thresholds, whole share quantity (optionally after rounding as described above) and security identifier from the trust or directly from the record keeping system to a broker dealer or other entity for execution in a conventional fashion, with the type of order, threshold or thresholds, security identifier and (optionally rounded) whole share number of shares, and receiving an order identifier from the broker dealer or other entity. The order identifier is stored with the original unrounded order. Orders may be provided to the broker dealer via the trust or from the record keeping system directly, which receives and stores the order identifier.

If the order is executed, the broker dealer or other entity that executes the order provides the order identifier and the number of shares that were actually bought or sold and the price or prices of execution to the trust, which forwards such information to the record keeping system, or to the record keeping system directly. At the record keeping system or the trust, if the order was filled, the number of shares bought or sold is subtracted from the original order (or vice versa) to identify a difference, assigned a positive value for shares to be added to the recon outage and a negative value for shares to be subtracted from the recon outage. At that time, any fractional share portion to be allocated to the order via an increase or decrease to the recon outage is transferred to or from the recon outage subaccount from or to the omnibus account for the trust and the transfer is accounted for using the average, highest, or lowest price of the executed order. In one embodiment, an expired order, or a partly filled order, is not treated as having a fractional share component.

### Handling of Dollar Certain Orders.

In one embodiment, market orders or other types of orders may include dollar or dollar certain orders. A dollar certain order is an order that is traded at the market to use or obtain as close to all of the dollars specified as possible, without exceeding the dollars specified. An indication that the order is a dollar or dollar certain order may be received (either explicitly or implicitly via standing instructions) at the record keeping system with the order along with the dollar amount and identifier of the security to be traded and provided to the broker dealer by the record keeping system, which stores such information along with an order identifier issued by the broker dealer, optionally via the trust. However, in such embodiment, no rounding is performed, as the order is provided in dollars instead of shares. In such embodiment, the market price of the security is identified by the broker dealer and then an order for a number of shares that results in the purchase or sale of as many securities as possible without exceeding the dollar amount is executed.

If the order is a dollar certain order, the number of shares in the order executed from the omnibus account by the broker dealer may be reduced by an amount that is a margin of error to account for market price fluctuations, and the margin of error may be a function of the recent stability of the price of the security being traded. One or more subsequent trades may be performed by the broker dealer to obtain a result closer to the dollar amount, all such trades being whole share trades performed in a conventional manner. The record keeping system or trust may perform this function instead of the broker dealer, issuing conventional market orders for a number of shares after identifying the appropriate number of shares and issuing one or more subsequent market orders.

The broker dealer identifies the number of whole shares ultimately purchased and amount of money used and returns such information to the record keeping system with the order identifier (or the record keeping system identifies such information), and the result will be in a whole number of shares and may not reach the dollar amount specified due to the use of only whole shares. The record keeping system may then complete the order using a fractional share from the recon outage, at the highest, lowest, or average price paid for the whole number of shares portion of the order, transferring the fractional share from the recon outage of the security purchased or sold and accounting for it as described above.

### If More Orders.

If any more orders have been received at the trust 228, then a next order may be selected at the trust, and the method continues at step 212 with the newly selected order.

### If No More Orders.

If no more orders have been received at the trust 228, then the method continues at step 210.

### III. Managing the Recon Outage Accounts.

At any time that the recon outage has changed, the number of shares of any security allocated by the trust to recon outage in the omnibus account may be checked by the trust to determine if any such number of shares allocated to the recon outage for that security is to be adjusted in any manner. In one embodiment, this occurs after an order that includes a fractional share component is complete. An order may be partially filled, and thus may be partially executed and not complete. Thus, the last execution in a series of executions of an order may be designated as the execution containing any fractional share from the order, though other executions of a part of an order may be considered to have the fractional share.

### Record Keeping System Identifies if Recon Outage for Any Security in the Order Should be Set Up and Directs Trust or Broker Dealer to Do So.

At any time after an order is determined to be completely filled 246, the method continues at step 234 of FIG. 2B. At step 234 of FIG. 2B, a determination is made as to whether the amount of the security in the order contains a fractional share 234. If the amount of the security in the order does not contain a fractional share 236, the branch terminates at step 270 of FIG. 2C. If the amount of the selected security in the order contains a fractional share 236, a determination is made as to whether a recon outage is being maintained for the selected security 238. If a recon outage is currently being maintained for the selected security as described herein 240, the method continues at step 252 at step 270 of FIG. 2C. Otherwise 240, the security is identified in the recordkeeping system as one for which a recon outage is currently being maintained 242, the trust is notified to purchase the target number of shares of the security for the recon outage, and the trust purchases, via the broker dealer, the target number of shares using a proprietary account of the trust and transfers the target number of shares to the recon outage subaccount for the security 244 and the branch terminates at step 270 of FIG. 2C.

### Compare Recon Outage for the Security to the Thresholds, Keep Recon Outage Within Threshold, Report if Outside Policy Thresholds.

At step 252, the amount of shares of the security corresponding to the order which are allocated as recon outage in the omnibus account is identified after the recon outage from the completed order is computed as described in steps 222 and 224, and such recon outage amount is compared to an upper threshold and an upper policy threshold. In one embodiment, the upper threshold may be a maximum threshold amount corresponding to a desired amount of shares of the security to be allocated to recon outage in the omnibus account. The upper policy threshold, which may be greater than the upper threshold, is an amount of shares which, if reached, may indicate a need to re-evaluate the rounding rule or rules being used to determine whether an amount of shares in the order including fractional shares should be rounded up or down to the nearest whole number, as described above, to reevaluate the upper threshold, or to re-evaluate any other management policies corresponding to orders described herein.

If Recon Outage Is Above The Upper Threshold, Then Reduce By Number Of Whole Shares Nearest Target, Transfer To Proprietary Account, And Sell From Proprietary Account.

If the amount of shares of the security allocated to recon outage exceeds the upper threshold 254, then an upper adjustment amount of shares of the security are transferred from the recon outage for the security to a proprietary account, and such transferred security shares are sold via a market order in a conventional manner of selling securities via the proprietary account 256. In one embodiment, the proprietary account at the trust may be an account owned by the trust and used by the trust for any of its internal business operations. In one embodiment, the upper adjustment amount corresponding to the security in the omnibus account may be identified as a whole number of shares by which the recon outage corresponding to such security may be reduced to bring such recon outage closest to a target recon outage amount for that security. The target recon outage amount corresponding to the security in the order may be an amount of shares of the security desired to be allocated to recon outage in the omnibus account during the trading day.

For example, if recon outage corresponding to ETF ABC is identified as 9.2 shares (which is 4.2 shares greater than an upper threshold of 5), and the target recon outage amount is 3 shares, then a whole number by which 9.2 shares may be reduced to bring 9.2 shares closest to 3 shares may be identified as 6:9.2−6=3.2. Thus, the upper adjustment amount is identified as 6 shares.

In one embodiment, any monetary funds gained from the sale of such ETF shares may remain in the proprietary account.

If recon outage corresponding to the security in the order exceeds the upper threshold 254, but does not exceed the upper policy threshold 258, then the branch terminates at step 270.

### If Recon Outage Is Also Above Upper Policy Threshold, Then Notify Management.

If the recon outage amount corresponding to the security in the order is also above the upper policy threshold 258, then management may be notified 260. In one embodiment, if management is notified of a recon outage amount corresponding to a security exceeding the upper policy threshold, then a different and/or adjusted rounding rule or rules to determine how an amount of shares including fractional shares is rounded to a whole number of shares, as described above with respect to step 216 of FIG. 2A, may be identified and/or used to replace or adjust the rounding rule or rules used at the time when such recon outage amount exceeded the upper policy threshold, or a different set of thresholds and/or target may be assigned to the security, all as part of step 260. The method continues at step 270.

### If Recon Outage Is Not Above Upper Threshold, And If Recon Outage Is Below Lower Threshold, Then Identify Smallest Number Of Whole Shares Nearest Target, Buy In Proprietary Account, And Transfer To Omnibus.

If the recon outage amount corresponding to the security in the order is not above the upper threshold 254, and the recon outage amount corresponding to the security is
below a lower threshold 262, then shares of the security may be purchased using the proprietary account and transferred from the proprietary account to the omnibus account 264, each at the broker dealer. In one embodiment, a lower adjustment amount of shares of the security may be purchased via the proprietary account corresponding to the security, with such lower adjustment amount corresponding to the security having been identified as a whole number by which the recon outage corresponding to the security may be increased to bring such recon outage corresponding to the security closest to the target recon outage amount.

When shares are transferred from the proprietary account to the omnibus account of the trust at the broker dealer, they may be allocated by the trust to recon outage corresponding to the security in the omnibus account. In one embodiment, any shares purchased for the proprietary account may be paid for using funds from the proprietary account, such as those added to the proprietary account when excess shares are sold using such account, as described above with respect to step 256. In one embodiment, such proprietary account at the trust may initially be seeded with monetary funds by the trust, and the trust may add any additional monetary funds to the proprietary account at any time.

If recon outage corresponding to the security is less than the lower threshold, but is not lower than the lower policy threshold 266, then the branch terminates at step 270.

### If Recon Outage Is Also Below Lower Policy Threshold, Then Notify Management.

If the recon outage corresponding to the security is also below the lower policy threshold 266, then the method continues at step 260.

### If Recon Outage Is Not Above Upper Threshold, And Recon Outage Is Not Below The Lower Threshold, Then Terminate Branch of FIGS. 2B and 2C.

If the recon outage corresponding to the security in the order is not above the upper threshold 254, and if such recon outage amount is not below the lower threshold 262, then the branch terminates at step 270.

### End of Day Risk Management for Recon Outage Accounts: Eliminate Whole Share Balances and Deficits

Referring now to FIG. 2D, a method of managing risk of multiple recon outage accounts containing securities or a deficit of securities is shown according to one embodiment of the present invention. In one embodiment, the method waits until the end of the day 280, such as, at the end of the regular trading day. A first security with a recon outage is selected 282. The balance of the recon outage of the selected security is identified, and a trade of whole shares is identified that will bring the balance greater than or equal to zero shares but less than one share 284. If such a trade is identified as zero 286, the method continues at step 290. Otherwise 286, the trust is notified of the trade, and the trust makes the trade identified, via the proprietary account of the trust at the broker-dealer using the after-hours market, with a conventional T+2 settlement 288. If the trade amount is greater than zero, shares being traded are transferred from the recon outage of the omnibus account at the broker-dealer to the proprietary account. If the trade is less than zero, implying that shares are to be purchased, shares are purchased using the proprietary account at the broker-dealer, and transferred to the recon outage account. Such a trade would be made if there were a deficit in the number of shares in the recon outage account at the end of the day. The method continues at step 290.

It may be possible for the trade to entirely eliminate the balance of the recon outage account. If the balance of the recon outage account after the trade is equal to zero 290, the security is identified as one without a recon outage 292, and the method continues at step 294. Otherwise 290, the method continues at step 294.

At step 294, if there are more securities with a recon outage, the next security with a recon outage is selected 296, and the method continues at step 284 using the newly selected security. Otherwise 294, the method continues at step 280, where the method will wait until the end of the next day and repeat.

### IV. System.

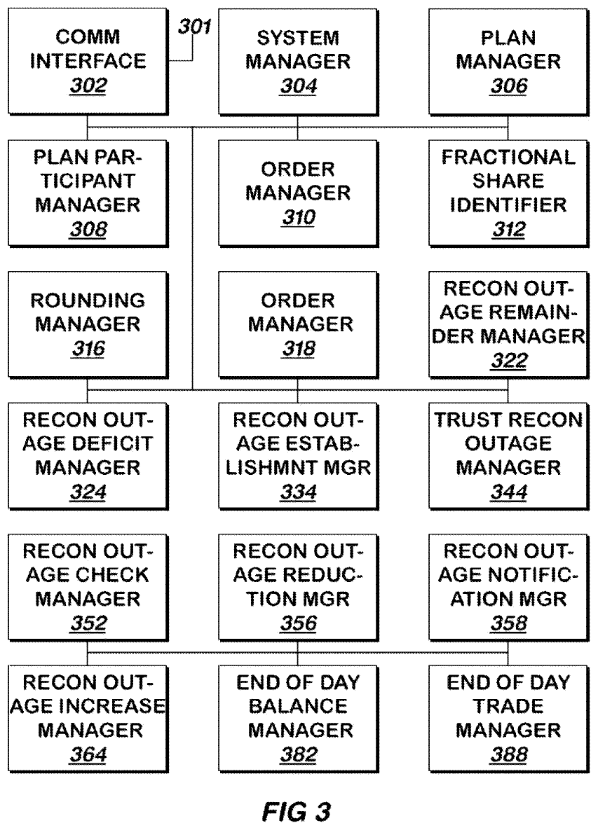

Referring now to FIG. 3, a system for allowing the trading, via retirement or other accounts, of quantities of securities containing fractional share amounts is shown according to one embodiment of the present invention. In one embodiment, the system consists of a trust component and a record keeping component, however, they may both be parts of the same physical computer system as described herein, or different systems. The elements of the system shown in the figure may each include a processor subsystem coupled to a memory subsystem as described herein.

Communication interface 302 includes a conventional communication interface running suitable communication protocols, such as Ethernet, TCP/IP, or both. In one embodiment, unless otherwise noted herein, all communication in or out of the system is made via input/output 301 of communication interface 302. Input/output 301 may be coupled to an Ethernet, the Internet, or both, or it may be coupled to any conventional computer communication channel. In the embodiment in which different components are used, each component has a similar communication interface with which the two components communicate with each other and the various users described herein.

System manager 304 receives from a system administrator the investment universe and plan additions, as well as the targets and thresholds each investment or for all securities or for each class of security in the investment universe. If classes of securities are used, system manager 304 receives the assignments of each security in the investment universe to the class to which it should correspond. System manager 304 stores all such information into system storage 336 and indicates in system for each security that no recon outage is currently being maintained for the security. System manager 304 also receives plan information, such as an identifier of each plan, and the plan manager or managers username and password and any plan additions (securities outside the plan universe that may be traded by specified plans) and the plan or plans to which they apply, and stores such information into plan storage 338. System manager 304 may receive such information, or updates to such information at any time, and system manager 304 stores such updates into system storage 336.

Plan manager 306 receives from a plan administrator who logs into plan manager 306 using the username and password supplied as described above, the plan investment options selected from the universe and plan additions corresponding to the plan associated with the username and password and that are stored in system 336 and displayed by plan manager 306. Plan manager 306 stores into plan storage 338 such selections associated with the plan with which the plan administrator is associated. Additionally, plan manager 306 receives information regarding the plan participants who are allowed to trade securities using the system, such as names and Social Security numbers of the plan participants, as well as usernames and passwords associated with each such plan participant, and stores such information into plan participant storage 340, along with the identifier of the plan to which the plan administrator corresponds, and a unique participant identifier it assigns.

Plan participant manager 310 allows plan participants to log in at any time using the participant username and password described above and provide standing allocation instructions as described above. Such standing allocations are stored by plan participant manager 310 into plan participant storage 340 associated with the participant identifier.

At any time, participant manager 310 receives plan participant orders, redemption requests and contributions, optionally with allocations to securities as described above. Participant manager 310 optionally converts contributions or redemption requests received in dollar amounts into one or more orders for securities via the allocation instructions received or via standing allocation instructions for the participant stored in plan participant storage 340 if no allocations are received with the order, contribution or redemption request. Participant manager 310 optionally aggregates the orders within a plan as described above, for example, aggregating orders entered by a system administrator who indicates the orders have been mailed, assigns a unique identifier to each order. Participant manager 310 stores the order or orders, and an identifier of the plan to which the participant corresponds into plan participant storage associated with an identifier of the plan participant or participants from which the order was received as an order object in plan participant storage 340. The order consists of a security identifier, a quantity, and an action, such as sell at the market price, any thresholds, dollar certain amounts received as part of the order or other information related to the order.

If the order is aggregated, in one embodiment, the number of shares in the order allocated to each participant is stored with the order object in plan participant storage 340, and such order object is associated with each such plan participant.

### Processing the Order.

When it receives the order object, fractional share identifier 312 determines if the order includes any fractional shares of the security corresponding to the order. If not, fractional share identifier 312 provides the order object to order manager 318, which places or executes the order as described herein using the omnibus account. The order may be executed via a conventional broker-dealer via a conventional stock exchange, or otherwise as described herein. An order may be placed but not executed, for example by recording it as a limit order or other type of order described herein that is not immediately placed. If the order includes fractional share amounts, fractional share identifier 312 provides the order object to rounding manager 318, which rounds the quantity of securities in the order up or down using a rounding rule as described herein and stores the rounded quantity in the order object. Rounding manager 316 adds the amount of rounding, with a positive amount signaling rounding up, and in a negative amount signaling rounding down, or vice versa, into the order object and provides it to order manager 318, which places or executes the rounded order as described herein. If order manager 318 does not execute the order immediately, order manager 318 stores the order object in trust storage 342, optionally including in the order object an expiration date and time that it assigns, which is a threshold amount of time from the current date and time, unless an earlier expiration date and time was provided by the participant with the order, contribution or redemption request. Order manager 318 may monitor market prices and compare them to unexpired orders stored in trust storage 342, for example limit orders to be placed in a limit price is reached. When the order is to be executed, order manager 318 retrieves the order object from trust storage 342, and executes the order as described herein. Partially filled orders may be split into multiple orders by order manager 318, with each portion of the order filled corresponding to one of the split orders and treated as an executed order as described herein, with the unfulfilled remainder of the partially filled order being stored in trust storage 342. A similar process may be used for dollar certain orders by order manager 318 as described above.

When it executes the order, order manager 308 identifies any amount of rounding that was indicated in the order. Order manager 318 adds to the order object of the executed order, the price or prices and quantities at which the order was executed, and provides the order object to participant manager 310. If the order was fully executed, or if the order corresponds to the completion of an original order that had been partially filled and the original order included a fractional share amount, order manager 318 also provides the order object to recon outage establishment manager 334.

When it receives the order object, participant manager 310 stores into plan participant storage 340, the order object along with the date and time. Participant manager 310 uses the order identifier to match the order to the participant or participants, and credits and/or debits the user's account in accordance with the order object. If one or more objects are received for an aggregated order, the quantities and prices may be allocated by participant manager 310 pro rata to each participant corresponding to the aggregated order stored in plan participant storage 340. Additionally, if the order was rounded in such a manner to produce an excess of shares after the order was executed, order manager 318 provides the order object to recon outage remainder manager 322. If the order was rounded in such a manner to produce a deficit of shares after the order was executed, order manager 318 provides the order object to recon outage deficit manager 324. Additionally, order manager 318 allocates in trust storage 342 the unrounded quantity in the order object to the plan corresponding to the identifier in the order object.

When it receives the order object, recon outage remainder manager 322 allocates the remainder to the omnibus account in trust storage 342 as recon outage for the security corresponding to the order. When it receives the order object, recon outage deficit manager 324 allocates from the recon outage the partial share used for the rounding in the omnibus account in trust storage 342. Additional orders are processed as described above.

### Establishing the Recon Outage.

When it receives an order object, recon outage establishment manager 334 checks system storage 336 to identify whether or not a recon outage is being maintained for the security corresponding to the order object it receives. If such a recon outage is being maintained the security, recon outage establishment manager 334 provides the order object to recon outage check manager 352. Otherwise, recon outage establishment manager 334 indicates in recon outage storage 336 that the security is one for which the recon outage is being maintained, retrieves the target for the security from system storage 336 and provides the identifier of the security and the target to trust recon outage manager 344, which purchases the target amount of the security for the recon outage account using the proprietary account and transferring the shares to the recon outage subaccount for the security as described above, and records the purchase and transfer in trust storage 342.

### Managing the Recon Outage.

When recon outage check manager 352 receives the order object, recon outage check manager 352 checks the recon outage for the security corresponding to the order that is stored in trust storage 342, compares the result to the upper and lower thresholds for the security stored in system storage 336 and computes any difference between the nearest threshold and the amount of the recon outage if the amount of the recon outage is outside of the upper or lower thresholds. If the recon outage is above the upper threshold, recon outage check manager 352 provides the identifier of the security in the order object and the difference between the quantity of the recon outage and the upper threshold to recon outage reduction manager 356. If the result is below the lower threshold, recon outage check manager 352 provides the identifier of the security and the difference between the quantity of the recon outage and the lower threshold to recon outage increase manager 364.

In addition to the above, recon outage check manager 352 compares the result to the policy thresholds for the security corresponding to the order object it receives that are stored in system storage 336 and computes the difference between the recon outage and the nearest policy threshold. If the result is outside the policy thresholds, recon outage check manager 352 provides the identifier of the security, the difference between the recon outage and the nearest policy threshold, the target, upper and lower threshold and such nearest policy threshold for the security corresponding to the order to recon outage notification manager 358.

When it receives the identifier of the security and the difference, recon outage reduction manager 356 transfers the difference amount for the security from the recon outage account to the proprietary account, sells such excess from the proprietary account, for example via a conventional securities broker-dealer and stock exchange and credits the funds received to the proprietary account as described above.

When it receives the identifier of the security and the difference, recon outage increase manager 364 uses funds in the proprietary account to purchase the difference amount for the security via a conventional broker-dealer via the proprietary account and transfers the difference purchased to the recon outage subaccount for the security as described above.

When it receives the identifier of the security, the difference, the target and thresholds, recon outage notification manager 358 stores such information into trust storage 342. At a certain time, such as the end of the day, or several times throughout the day, recon outage notification manager 358 provides, such as via e-mail, reports to a management team with the information received since the last such report. In one embodiment, recon outage notification manager 358 may adjust the target and/or upper and/or or lower thresholds in response to the information that has stored, and store such changes into trust storage 342. For example, if the upper policy threshold is repeatedly exceeded, the target, upper threshold, upper policy threshold, and optionally the other thresholds, may be increased. Additionally, recon outage notification manager 358 stores such changes associated with the identifier of the security in system storage 336.

### End of Day Elimination of Whole Share Balance.

At the end of the trading day (or at the last market close if after hours markets are used) end of day balance manager 382 identifies any securities with a recon outage containing any whole share amounts, and identifies the securities and the whole share amounts that should be traded to bring the recon outage for the security to less than one share but greater than or equal to zero shares, and indicates to end of day trade manager 388 the identifiers of such securities and such whole share amounts.

End of day trade manager 388 transfers such share amounts to or from the proprietary account from the recon outage subaccount for such security, and performs the trade as described above, for example via a broker dealer and optionally via a stock exchange (or using a last price listed on the stock exchange or an after hours price, or a price related to one or both of these prices) via the proprietary account, to cause the quantity of each such security in the recon outage subaccounts to be greater than or equal to zero, but less than one.

End of day balance manager 382 identifies each security in system storage 336 as one without a recon outage if the trade by end of day trade manager 388 results in a recon outage of zero shares.

At the first trade of a security at the next day, if the amount of the recon outage is below the threshold, the security will be purchased to bring it near the target amount as described above.

### SUMMARY

There is described a method of processing several orders, each order specifying a portion of a share of at least one of several exchange traded funds to be traded, the orders being received for each of several retirement plans, the method including: providing a pool of at least one share of each of the several exchange traded funds; receiving, from a first of the several retirement plans, a first of the several orders specifying a first of the portions of the share of a first of the several exchange traded funds; at least one selected from a first group including: contributing a first at least a portion of a share of the first of the several exchange traded funds from the pool, to the first of the portions of the share of a first of the several exchange traded funds from the first of the several orders, so that a first possible trade corresponding to the first at least the portion of the share of the first of the several exchange traded funds from the pool and the first of the portions of the share of the first of the several exchange traded funds from the first of the several orders equals a whole number of at least one share of the first of the several exchange traded funds; and contributing at least some of the first of the portions of the share of a first of the several exchange traded funds to the first of the at least one share of the several exchange traded funds of the pool, so that a second possible trade corresponding to the first of the several orders and the first of the portions of the share of a first of the several exchange traded funds contributed to the pool of the first of the several exchange traded funds equals a whole number of at least one share of the first of the several exchange traded funds; receiving, from a second of the several retirement plans, a second of the several orders comprising a second of the portions of the share of the first of the several exchange traded funds; at least one selected from a second group including: contributing a second at least a portion of a share of the first of the several exchange traded funds from the pool, to the second of the portions of the share of the first of the several exchange traded funds, so that a third possible trade corresponding to the second at least the portion of the share of the first of the several exchange traded funds from the pool and the second of the portions of the share of the first of the several exchange traded funds from the second of the several orders equals a whole number of at least one share of the first of the several exchange traded funds; and contributing at least some of the second of the portions of the share of a first of the several exchange traded funds to the at least one share of the first of the several exchange traded funds of the pool, so that a fourth possible trade corresponding to the second of the several orders equals a whole number of at least one share of the first of the several exchange traded funds; initiating, before an end of a trading day, at least one trade corresponding to at least one selected from the group comprising the first possible trade and the second possible trade; and initiating, before the end of the trading day, at least one trade corresponding to at least one selected from the group comprising the third possible trade and the fourth possible trade.

The method may include the additional step of accounting for the trading steps so that: an account of a first participant of the first retirement plan who placed the first of the several orders receives the effect of the first of the several orders, even though the at least one trade is different in quantity of the first of the several exchange traded funds from a quantity of the first of the several exchange traded funds specified by the first of the several orders; and an account of a second participant of the first retirement plan who placed the second of the several orders receives the effect of the second of the several orders, even though the at least one trade is different in quantity of the first of the several exchange traded funds from a quantity of the first of the several exchange traded funds specified by the second of the several orders.

The method may include an optional feature whereby, responsive to the first retirement plan and the second retirement plan comprising a same retirement plan, the at least one trade includes a single combined trade corresponding to at least one selected from the first possible trade and the second possible trade, and at least one selected from the third possible trade and the fourth possible trade.

The method may include an optional feature whereby at least one selected from: a mathematic combination of the first at least the portion of the share of the pool of the first of the several exchange traded funds, and the first of the portions of the share of a first of the several exchange traded funds from the first of the several orders equals a whole number; a mathematic combination of the second at least a portion of the share of the pool of the first of the several exchange traded funds, and the second of the portions of the share of a first of the several exchange traded funds from the second of the several orders equals a whole number; the at least some of the first of the portions of the share of a first of the several exchange traded funds contributed to the pool of the first of the several exchange traded funds is all of the first of the portions of the share of a first of the several exchange traded funds; and the at least some of the second of the portions of the share of a first of the several exchange traded funds contributes to the pool of the first of the several exchange traded funds is all of the second of the portions of the share of a first of the several exchange traded funds.

The method may additionally include selling substantially all of a whole number of shares in the pool according to a schedule.

The method may additionally include: monitoring a number of shares of each of the exchange traded funds in the pool; and selling some of a number of whole shares of at least one of the exchange traded funds in the pool, responsive to the number of shares of each said at least one exchange traded fund in the pool exceeding a threshold.

The method may additionally include: monitoring a number of shares of each of the exchange traded funds in the pool; and buying at least one share of at least one of the exchange traded funds for the pool, responsive to the number of shares of each said at least one exchange traded fund in the pool being below a threshold.

There is described a system for processing several orders, each order specifying a portion of a share of at least one of several exchange traded funds to be traded, the orders being received for each of several retirement plans, the system including: a digital storage for providing via an input/output access to a pool account corresponding to a pool of at least one share of each of the several exchange traded funds; an order communication manager having an input for receiving, from a first of the several retirement plans, a first of the several orders specifying a first of the portions of the share of a first of the several exchange traded funds, and for receiving, from a second of the several retirement plans, a second of the several orders comprising a second of the portions of the share of the first of the several exchange traded funds the order communication manager for providing at an output said first of the several orders and the second of the several orders; a round manager comprising a computer processor and having an input coupled to the order communication manager output for receiving the first of the several orders and the second of the several orders, and an input/output coupled to the digital storage for accessing the pool account, the round manager for at least one selected from a first group including: identifying a first amount of a first at least a portion of a share of the first of the several exchange traded funds to be contributed from the pool to the first of the portions of the share of a first of the several exchange traded funds from the first of the several orders, so that a first possible trade corresponding to the first at least the portion of the share of the first of the several exchange traded funds from the pool and the first of the portions of the share of the first of the several exchange traded funds from the first of the several orders equals a whole number of at least one share of the first of the several exchange traded funds, identifying a second amount of at least some of the first of the portions of the share of a first of the several exchange traded funds to be contributed to the first of the at least one share of the several exchange traded funds of the pool, so that a second possible trade corresponding to the first of the several orders and the first of the portions of the share of a first of the several exchange traded funds contributed to the pool of the first of the several exchange traded funds equals a whole number of at least one share of the first of the several exchange traded funds, the round manager additionally for at least one selected from a second group comprising: identifying an third amount of a second at least a portion of a share of the first of the several exchange traded funds from the pool, to be contributed to the second of the portions of the share of the first of the several exchange traded funds, so that a third possible trade corresponding to the second at least the portion of the share of the first of the several exchange traded funds from the pool and the second of the portions of the share of the first of the several exchange traded funds from the second of the several orders equals a whole number of at least one share of the first of the several exchange traded funds, and identifying a fourth amount of at least some of the second of the portions of the share of a first of the several exchange traded funds to be contributed to the at least one share of the first of the several exchange traded funds of the pool, so that a fourth possible trade corresponding to the second of the several orders equals a whole number of at least one share of the first of the several exchange traded funds, the round manager additionally for providing at an output at least one selected from information about the first possible trade, information about the second possible trade, information about the third possible trade and information about the fourth possible trade; an order execution manager having an input coupled to the round manager output for receiving the information about at least one selected from the first possible trade, the second possible trade, the third possible trade and the fourth possible trade, the order execution manager for initiating, before an end of a trading day, at least one trade corresponding to at least one selected from the group comprising the first possible trade, the second possible trade, the third possible trade and the fourth possible trade.

The system may additionally include an order allocation manager having an input coupled to the order communication manager output for receiving the first of the several orders and the second of the several orders, the order allocation manager for accounting for the trading step via an output so that: an account of a first participant of the first retirement plan who placed the first of the several orders receives the effect of the first of the several orders, even though the at least one trade is different in quantity of the first of the several exchange traded funds from a quantity of the first of the several exchange traded funds specified by the first of the several orders; and an account of a second participant of the first retirement plan who placed the second of the several orders receives the effect of the second of the several orders, even though the at least one trade is different in quantity of the first of the several exchange traded funds from a quantity of the first of the several exchange traded funds specified by the second of the several orders.

The system may contain an optional feature whereby the order execution manager initiates the at least one trade as part of a single combined trade corresponding to at least one selected from the first possible trade and the second possible trade, and at least one selected from the third possible trade and the fourth possible trade, responsive to the first retirement plan and the second retirement plan comprising a same retirement plan.

The system may contain an optional feature whereby at least one selected from: a mathematic combination of the first at least the portion of the share of the pool of the first of the several exchange traded funds, and the first of the portions of the share of a first of the several exchange traded funds from the first of the several orders equals a whole number; a mathematic combination of the second at least a portion of the share of the pool of the first of the several exchange traded funds, and the second of the portions of the share of a first of the several exchange traded funds from the second of the several orders equals a whole number; the at least some of the first of the portions of the share of a first of the several exchange traded funds contributed to the pool of the first of the several exchange traded funds is all of the first of the portions of the share of a first of the several exchange traded funds; and the at least some of the second of the portions of the share of a first of the several exchange traded funds contributes to the pool of the first of the several exchange traded funds is all of the second of the portions of the share of a first of the several exchange traded funds.

The system may additionally include: a remainder manager coupled to the round manager output for additionally for receiving the at least one selected from information about the first possible trade, information about the second possible trade, information about the third possible trade and information about the fourth possible trade, the remainder manager for updating via an input/output coupled to the digital storage input/output the pool account responsive to the at least one selected from information about the first possible trade, information about the second possible trade, information about the third possible trade and information about the fourth possible trade; an end of day balance manager having an input/output coupled to the digital storage for monitoring the pool account and identifying a number of shares of each of the several exchange traded funds in the pool, the end of day balance manager for identifying a whole number of shares of substantially all of each of the several exchange traded funds in the pool and for providing at an output the whole number of shares identified for each of the several exchange traded funds, responsive to a schedule; and an end of day trade manager having an input coupled to the end of day balance manager for receiving the whole number of shares identified for each of the several exchange traded funds, the end of day trade manager for initiating via an output, a sale from the pool of the whole number of shares of each of the exchange traded funds received at the end of day trade manager input.

The system may additionally include: a remainder manager coupled to the round manager output for additionally for receiving the at least one selected from information about the first possible trade, information about the second possible trade, information about the third possible trade and information about the fourth possible trade, the remainder manager for updating via an input/output coupled to the digital storage input/output the pool account responsive to the at least one selected from information about the first possible trade, information about the second possible trade, information about the third possible trade and information about the fourth possible trade; a check manager having an input/output coupled to the digital storage input/output for monitoring a number of shares of each of the exchange traded funds in the pool, the check manager for identifying and providing at an output, a number of whole shares of at least one of the exchange traded funds to be sold from the pool, responsive to the number of shares of each said at least one exchange traded fund in the pool exceeding a threshold; and a reduction manager having an input coupled to the check manager output for receiving the whole number of shares of the at least one of the exchange traded funds to be sold from the pool, the reduction manager for initiating a sale from the pool of the whole number of shares of the at least one of the exchange traded funds received at the reduction manager input.

The system may additionally include: a remainder manager coupled to the round manager output for additionally for receiving the at least one selected from information about the first possible trade, information about the second possible trade, information about the third possible trade and information about the fourth possible trade, the remainder manager for updating via an input/output coupled to the digital storage input/output the pool account responsive to the at least one selected from information about the first possible trade, information about the second possible trade, information about the third possible trade and information about the fourth possible trade; a check manager having an input/output coupled to the digital storage input/output for monitoring a number of shares of each of the exchange traded funds in the pool, the check manager for identifying and providing at an output, a number of whole shares of at least one of the exchange traded funds to be purchased from the pool, responsive to the number of shares of each said at least one exchange traded fund in the pool being below a threshold; and an increase manager having an input coupled to the check manager output for receiving the whole number of shares of the at least one of the exchange traded funds to be sold from the pool, the reduction manager for initiating a purchase for the pool of the whole number of shares of the at least one of the exchange traded funds received at the increase manager input.

A computer program product including a computer useable medium having computer readable program code embodied therein is described for processing several orders, each order specifying a portion of a share of at least one of several exchange traded funds to be traded, the orders being received for each of several retirement plans, the computer program product including computer readable program code devices configured to cause a computer system to: provide a pool of at least one share of each of the several exchange traded funds; receive, from a first of the several retirement plans, a first of the several orders specifying a first of the portions of the share of a first of the several exchange traded funds; at least one selected from a first group including: contribute a first at least a portion of a share of the first of the several exchange traded funds from the pool, to the first of the portions of the share of a first of the several exchange traded funds from the first of the several orders, so that a first possible trade corresponding to the first at least the portion of the share of the first of the several exchange traded funds from the pool and the first of the portions of the share of the first of the several exchange traded funds from the first of the several orders equals a whole number of at least one share of the first of the several exchange traded funds; and contribute at least some of the first of the portions of the share of a first of the several exchange traded funds to the first of the at least one share of the several exchange traded funds of the pool, so that a second possible trade corresponding to the first of the several orders and the first of the portions of the share of a first of the several exchange traded funds contributed to the pool of the first of the several exchange traded funds equals a whole number of at least one share of the first of the several exchange traded funds; receive, from a second of the several retirement plans, a second of the several orders including a second of the portions of the share of the first of the several exchange traded funds; at least one selected from a second group including: contribute a second at least a portion of a share of the first of the several exchange traded funds from the pool, to the second of the portions of the share of the first of the several exchange traded funds, so that a third possible trade corresponding to the second at least the portion of the share of the first of the several exchange traded funds from the pool and the second of the portions of the share of the first of the several exchange traded funds from the second of the several orders equals a whole number of at least one share of the first of the several exchange traded funds; and contribute at least some of the second of the portions of the share of a first of the several exchange traded funds to the at least one share of the first of the several exchange traded funds of the pool, so that a fourth possible trade corresponding to the second of the several orders equals a whole number of at least one share of the first of the several exchange traded funds; initiate, before an end of a trading day, at least one trade corresponding to at least one selected from the group comprising the first possible trade and the second possible trade; and initiate, before the end of the trading day, at least one trade corresponding to at least one selected from the group comprising the third possible trade and the fourth possible trade.

The computer program product may additionally include computer readable program code devices configured to cause the computer system to account for the trading steps so that: an account of a first participant of the first retirement plan who placed the first of the several orders receives the effect of the first of the several orders, even though the at least one trade is different in quantity of the first of the several exchange traded funds from a quantity of the first of the several exchange traded funds specified by the first of the several orders; and an account of a second participant of the first retirement plan who placed the second of the several orders receives the effect of the second of the several orders, even though the at least one trade is different in quantity of the first of the several exchange traded funds from a quantity of the first of the several exchange traded funds specified by the second of the several orders.

The computer program product may contain an optional feature whereby, responsive to the first retirement plan and the second retirement plan comprising a same retirement plan, the at least one trade includes a single combined trade corresponding to at least one selected from the first possible trade and the second possible trade, and at least one selected from the third possible trade and the fourth possible trade.

The computer program product may contain an optional feature whereby at least one selected from: a mathematic combination of the first at least the portion of the share of the pool of the first of the several exchange traded funds, and the first of the portions of the share of a first of the several exchange traded funds from the first of the several orders equals a whole number; a mathematic combination of the second at least a portion of the share of the pool of the first of the several exchange traded funds, and the second of the portions of the share of a first of the several exchange traded funds from the second of the several orders equals a whole number; the at least some of the first of the portions of the share of a first of the several exchange traded funds contributed to the pool of the first of the several exchange traded funds is all of the first of the portions of the share of a first of the several exchange traded funds; and the at least some of the second of the portions of the share of a first of the several exchange traded funds contributes to the pool of the first of the several exchange traded funds is all of the second of the portions of the share of a first of the several exchange traded funds.

The computer program product may additionally include computer readable program code devices configured to cause the computer system to sell substantially all of a whole number of shares in the pool according to a schedule.

The computer program product may additionally include computer readable program code devices configured to cause the computer system to: monitor a number of shares of each of the exchange traded funds in the pool; and sell some of a number of whole shares of at least one of the exchange traded funds in the pool, responsive to the number of shares of each said at least one exchange traded fund in the pool exceeding a threshold.

The computer program product may additionally include computer readable program code devices configured to cause the computer system to: monitor a number of shares of each of the exchange traded funds in the pool; and buy at least one share of at least one of the exchange traded funds for the pool, responsive to the number of shares of each said at least one exchange traded fund in the pool being below a threshold.

What is claimed is:

1. A method of processing a plurality of orders, each order specifying a portion, less than all, of a share of at least one of a plurality of exchange traded funds to be traded, the orders being received for each of a plurality of retirement plans, the method comprising:
providing a pool of at least one share of each of the plurality of exchange traded funds to be traded by the plurality of retirement plans, the pool being held by a trust for the plurality of retirement plans;
receiving, from a first of the plurality of retirement plans, by a hardware processor coupled to a memory, a first order of the plurality of orders, the first order specifying a first amount that is other than a whole number of shares of a first of the plurality of exchange traded funds;
identifying, by the hardware processor coupled to the memory, a second amount that is a whole number of shares nearest to the first amount that complies with an identification rule defining that the second amount is to be a next whole number higher than the first amount;
adding, from the pool, a number of shares to the first amount such that a sum of the number of shares and the first amount equals the second amount;
directing an exchange to execute, before an end of a trading day, at least one trade of the first of the plurality of exchange traded funds for the second amount, higher than the first amount, the second amount including a first portion of a share corresponding to the pool;
allocating, by the hardware processor coupled to the memory, the first amount to the first of the plurality of retirement plans;
allocating, by the hardware processor coupled to the memory, a difference between the first amount and second amount to the pool;
monitoring a number of shares of each of the exchange traded funds in the pool;
determining a first set of exchange traded funds, the first set of exchange traded funds being exchange traded funds in the pool outside of a first threshold;
determining a second set of exchange traded funds, the second set of exchange traded funds being exchange traded funds in the pool outside of a second threshold, the second threshold being greater than the first threshold;
generating a report including the second set of exchange traded funds;
automatically adjusting the number of shares of each of the exchange traded funds of the first set of exchange traded funds to be within the first threshold; and
automatically adjusting one or more of the first threshold or the second threshold based on the first set of exchange traded funds and the second set of exchange traded funds.

2. The method of claim 1, additionally comprising selling a whole number of shares in the pool according to a schedule in response to the pool including at least one share.

3. The method of claim 1, wherein the automatically adjusting the number of shares of each of the exchange traded funds of the first set of exchange traded funds in the pool includes, for each exchange traded fund of the first set of exchange traded that exceeds an upper threshold of the first threshold, selling a number of shares of the exchange traded fund to reduce the number of shares of the exchange traded fund to be equal to a set amount, the set amount being less than the upper threshold of the first threshold.

4. The method of claim 1, wherein the automatically adjusting the number of shares of each of the exchange traded funds of the first set of exchange traded funds in the pool includes, for each exchange traded fund of the first set of exchange traded funds that is below a lower threshold of the first threshold, buying a number of shares of the exchange traded fund to increase the number of shares of the exchange traded fund to be greater than the lower threshold of the first threshold.

5. The method of claim 1, wherein the generating the report includes sending the report to a management team, the report further including at least one of the second threshold corresponding to each of the second set of exchange traded funds, a date, or a time.

6. The method of claim 1, wherein the automatically adjusting one or more of the first threshold or the second threshold includes increasing at least one of the first threshold or the second threshold in response to the first threshold or the second threshold being repeatedly exceeded.

7. A system for processing a plurality of orders, each order specifying a portion, less than all, of a share of at least one of a plurality of exchange traded funds to be traded, the orders being received for each of a plurality of retirement plans, the system comprising:
at least one processor;
at least one memory coupled to the at least one processor, wherein the memory includes instructions that when executed by the at least one processor cause the system to perform,
providing a pool of at least one share of each of the plurality of exchange traded funds to be traded by the plurality of retirement plans, the pool being held by a trust for the plurality of retirement plans;
receiving, from a first of the plurality of retirement plans, a first order of the plurality of orders, the first order specifying a first amount that is other than a whole number of shares of a first of the plurality of exchange traded funds;
identifying a second amount that is a whole number of shares nearest to the first amount that complies with an identification rule defining that the second amount is to be a next whole number higher than the first amount;
adding, from the pool, a number of shares to the first amount such that a sum of the number of shares and the first amount equals the second amount;
directing an exchange to execute, before an end of a trading day, at least one trade of the first of the plurality of exchange traded funds for the second amount, higher than the first amount, the second amount including a first portion of a share corresponding to the pool;
allocating the first amount to the first of the plurality of retirement plans;
allocating a difference between the first amount and second amount to the pool;
monitoring a number of shares of each of the exchange traded funds in the pool;
determining a first set of exchange traded funds, the first set of exchange traded funds being exchange traded funds in the pool outside of a first threshold;
determining a second set of exchange traded funds, the second set of exchange traded funds being exchange traded funds in the pool outside of a second threshold, the second threshold being greater than the first threshold;
generating a report including the second set of exchange traded funds;
automatically adjusting the number of shares of each of the exchange traded funds of the first set of exchange traded funds to be within the first threshold; and
automatically adjusting one or more of the first threshold or the second threshold based on the first set of exchange traded funds and the second set of exchange traded funds.

8. The system of claim 7, wherein the system is further caused to perform:
selling a whole number of shares in the pool according to a schedule in response to the pool including at least one share.

9. The system of claim 7, wherein the automatically adjusting the number of shares of each of the exchange traded funds of the first set of exchange traded funds in the pool includes, for each exchange traded fund of the first set of exchange traded funds-that exceeds an upper threshold of the first threshold, selling a number of shares of the exchange traded fund to reduce the number of shares of the exchange traded fund to be equal to a set amount, the set amount being less than the upper threshold of the first threshold.

10. The system of claim 7, wherein the automatically adjusting the number of shares of each of the exchange traded funds of the first set of exchange traded funds in the pool includes, for each exchange traded fund of the first set of exchange traded funds that is below a lower threshold of the first threshold, buying a number of shares of the exchange traded fund to increase the number of shares of the exchange traded fund to be greater than the lower threshold of the first threshold.

11. The system of claim 7, wherein the generating the report includes sending the report to a management team, the report further including at least one of the second threshold corresponding to each of the second set of exchange traded funds, a date, or a time.

12. The system of claim 7, wherein the automatically adjusting one or more of the first threshold or the second threshold includes increasing at least one of the first threshold or the second threshold in response to the first threshold or the second threshold being repeatedly exceeded.

13. A non-transitory computer readable medium having computer readable program code embodied therein for processing a plurality of orders, each order specifying a portion, less than all, of a share of at least one of a plurality of exchange traded funds to be traded, the orders being received for each of a plurality of retirement plans, the computer readable program code configured to cause a computer system to perform:
providing a pool of at least one share of each of the plurality of exchange traded funds to be traded by the plurality of retirement plans, the pool being held by a trust for the plurality of retirement plans;
receiving, from a first of the plurality of retirement plans, a first order of the plurality of orders, the first order specifying a first amount that is other than a whole number of shares of a first of the plurality of exchange traded funds;
identifying, by a hardware processor coupled to a memory, a second amount that is a whole number of shares nearest to the first amount that complies with an identification rule defining that the second amount is to be a next whole number higher than the first amount;
adding, from the pool, a number of shares to the first amount such that a sum of the number of shares and the first amount equals-the second amount;
directing an exchange to execute, before an end of a trading day, at least one trade of the first of the plurality of exchange traded funds for the second amount higher than the first amount, the second amount including a first portion of a share corresponding to the pool; and
allocating the first amount to the first of the plurality of retirement plans;
allocating a difference between the first amount and the second amount to the pool;
monitoring a number of shares of each of the exchange traded funds in the pool;
determining a first set of exchange traded funds, the first set of exchange traded funds being exchange traded funds in the pool outside of a first threshold;
determining a second set of exchange traded funds, the second set of exchange traded funds being exchange traded funds in the pool outside of a second threshold, the second threshold being greater than the first threshold;
generating a report including the second set of exchange traded funds;
automatically adjusting the number of shares of each of the exchange traded funds of the first set of exchange traded funds to be within the first threshold; and
automatically adjusting one or more of the first threshold or the second threshold based on the first set of exchange traded funds and the second set of exchange traded funds.

14. The non-transitory computer readable medium of claim 13, wherein the computer system is further caused to perform:
selling a whole number of shares in the pool according to a schedule in response to the pool including at least one share.

15. The non-transitory computer readable medium of claim 13, wherein the automatically adjusting the number of shares of each of the exchange traded funds of the first set of exchange traded funds in the pool includes, for each exchange traded fund of the first set of exchange traded funds-that exceeds an upper threshold of the first threshold, selling a number of shares of the exchange traded fund to reduce the number of shares of the exchange traded fund to be equal to a set amount, the set amount being less than the upper threshold of the first threshold.

16. The non-transitory computer readable medium of claim 13, wherein the automatically adjusting the number of shares of each of the exchange traded funds of the first set of exchange traded funds in the pool includes, for each exchange traded fund of the first set of exchange traded funds-that is below a lower threshold of the first threshold, buying a number of shares of the exchange traded fund to increase the number of shares of the exchange traded fund to be greater than the lower threshold of the first threshold.

17. The non-transitory computer readable medium of claim 13, wherein the generating the report includes sending the report to a management team, the report further including at least one of the second threshold corresponding to each of the second set of exchange traded funds, a date, or a time.

18. The non-transitory computer readable medium of claim 13, wherein the automatically adjusting one or more of the first threshold or the second threshold includes increasing at least one of the first threshold or the second threshold in response to the first threshold or the second threshold being repeatedly exceeded.
